(19) United States
(12) Patent Application Publication
(10) Pub. No.: US 2026/0065199 A1
(43) Pub. Date: Mar. 5, 2026

(54) RETAIL SHRINK MITIGATION AND PREVENTION

(71) Applicant: NCR Voyix Corporation, Atlanta, GA (US)

(72) Inventors: Itamar David Laserson, Givat Shmuel (IL); Shay Marom, Kiryat Tiv'on (IL)

(21) Appl. No.: 18/821,297

(22) Filed: Aug. 30, 2024

(51) Int. Cl. G06Q 10/0635

(52) U.S. Cl. CPC G06Q 10/0635

(57) ABSTRACT

A system and methods for preventing retail shrink utilizes two machine learning models that analyze real-time data from store systems and computer vision applications. The first model processes shrink incidents to identify risk factors, while the second model generates prescriptive recommendations based on these factors. These recommendations are provided via application programming interfaces (APIs) to store services, enabling real-time interventions such as alerting cashiers during transactions or advising managers on staffing decisions. The system continuously updates these models based on new data and effectiveness of the recommendations at mitigating shrink, allowing for both immediate shrink prevention and long-term reduction strategies. This approach addresses various types of shrink, including both non-deliberate and deliberate shrink, by providing actionable insights tailored to specific data driven risk factors.

### BACKGROUND

Retailers face significant financial losses due to shrink, with U.S. retailers alone losing $47 billion annually, accounting for approximately 2% of their revenue. While about one-third of this shrink is attributable to shoplifting, primarily at self-checkout lanes, an additional 40% is employee-related, stemming from both deliberate and non-deliberate employee actions. Existing technologies focus primarily on detecting shrink events after they occur, rather than preventing them. Even when predictive technologies are available, they often lack the capability to provide specific, actionable recommendations to prevent predicted shrink incidents. Furthermore, current solutions fail to address the complex interplay of factors contributing to shrink, such as time of day, basket content, checkout method, and employee behavior, leaving retailers without a comprehensive, proactive approach to mitigate losses effectively.

### BRIEF DESCRIPTION OF THE DRAWINGS

FIG. 1 is a diagram of a system for retail shrink mitigation and prevention, according to an example embodiment.

FIG. 2 is a flow diagram of a method for providing retail shrink mitigation and prevention, according to an example embodiment.

FIG. 3 is a flow diagram of another method for providing retail shrink mitigation and prevention, according to an example embodiment.

### DETAILED DESCRIPTION

As stated above, retail shrink continues to be a significant challenge for the industry, with U.S. retailers alone losing $47 billion annually, amounting to about 2% of their revenue. This problem is multifaceted, stemming from various sources including deliberate theft, employee-related shrink (both deliberate and non-deliberate), administrative errors, and perishable item spoilage.

While existing technologies focus primarily on detecting shrink events after they occur, they fall short in preventing future incidents of shrink. Even when predictive technologies are available, they often lack the ability to provide specific, actionable recommendations to prevent predicted shrink incidents.

A particular area of concern is the self-checkout system, where a significant portion of shrink occurs. Self-checkout faults, such as difficulties in scanning items, struggles with price lookup (PLU) menus, and equipment malfunctions, can lead to unintentional shrink events. These issues not only result in immediate losses but also create frustration for customers, potentially impacting their shopping experience and loyalty.

Furthermore, the complex interplay of factors contributing to shrink, such as time of day (e.g., time-related), basket content, checkout method, and employee behavior, makes it challenging for retailers to implement effective, comprehensive strategies to mitigate losses. The lack of real-time, data-driven insights and actionable recommendations leaves retailers without the tools to proactively address shrink events before they occur.

Embodiments of the invention address these challenges through a sophisticated, multi-layered approach to shrink prevention. Two machine learning MLMs (MLMs) work in tandem to analyze real-time data from store systems along with computer vision applications. The first MLM processes shrink incidents to identify risk factors, while the second MLM generates prescriptive recommendations based on these factors.

This dual-MLM approach allows for a more nuanced and effective analysis of shrink risks. By continuously updating the MLMs based on new data and the effectiveness of previous recommendations, the approach provides both immediate shrink prevention capabilities and long-term reduction strategies. The real-time nature of the system enables swift interventions, such as alerting cashiers during transactions or advising managers on staffing decisions, to prevent shrink events before they occur.

Moreover, the technique provides recommendations via application programming interfaces (API to various store services allowing for seamless integration into existing retail operations. This integration enables retailers to address shrink comprehensively across different aspects of their business, from individual transactions to overall store management.

By focusing on both detection and prevention, and by providing specific, actionable recommendations, embodiments of the invention offer a technical solution that solves technical problems associated with current shrink prevention technologies. The embodiments assess the complex factors contributing to shrink, including self-checkout faults, by analyzing verified shrink incidents to identify patterns and specific conditions that are exacerbating shrink for a retailer and providing targeted interventions to the retailer in the form of prescriptive shrink reduction recommendations that are tailored to mitigate the impact on shrink of the specific patterns and conditions. This approach not only helps in reducing immediate losses but also contributes to improving the overall shopping experience and operational efficiency of retail stores.

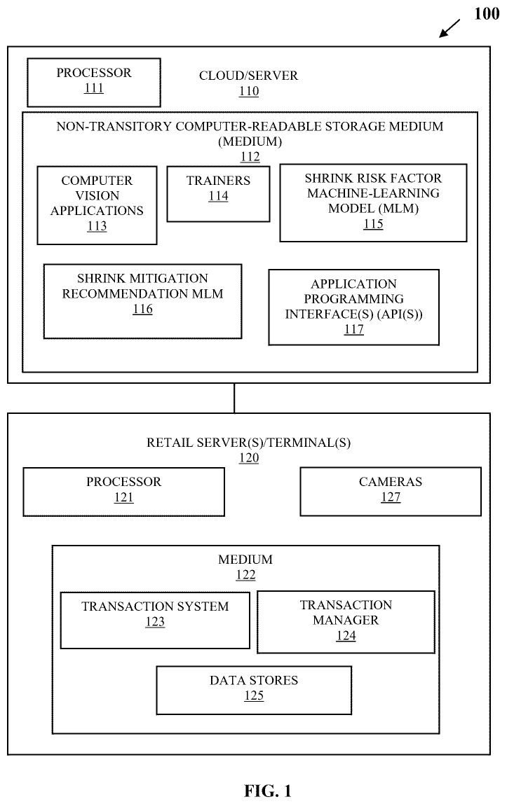

FIG. 1 is a diagram of a system 100 for retail shrink mitigation and prevention, according to an example embodiment. Notably, the components are shown schematically in greatly simplified form, with only those components relevant to understanding of the embodiments being illustrated.

Furthermore, the various components illustrated in FIG. 1 and their arrangement is presented for purposes of illustration only. It is to be noted that other arrangements with more or less components are possible without departing from the teachings of retail shrink mitigation and prevention.

System 100 includes a cloud 110 or a server 110 (hereinafter “cloud 110” or “cloud server 110”) and a plurality of enterprise servers/terminals 120. Cloud 110 includes a processor 111 and a non-transitory computer-readable storage medium (hereinafter “medium”) 112, which includes executable instructions for computer vision applications 113, MLM trainers 114, a shrink risk factor machine learning MLM (MLM) 115, a shrink mitigation recommendation MLM (MLM) 116, and one or more APIs 117. When processor 111 executes the instructions, this causes the processor 111 to perform operations discussed herein and below with respect to 113-117.

Each retailer server/terminal 120 includes a processor 121 and a medium 122, which includes executable instructions for a transaction system 123, a transaction manager 124, and one or more data stores 125. When processor 121 executes the instructions, this causes the processor 121 to perform operations discussed herein and below with respect to 123-124. It is to be noted that retailer server 120 can include a variety of other systems, such as an inventory system, a maintenance and support system, a scheduling system, etc. Moreover, access to data stores 125 and planograms 126 can be provided through APIs or data store interfaces and applications.

Each retail server/terminal 120 may also associated with cameras 127 situated throughout retail stores and/or integrated/interfaced to terminals 120 within the stores. The cameras 127 may capture video and/or images of areas throughout a given store of a retailer. The images may be stored in and/or streamed to network-accessible storage locations, which are accessible to cloud 110.

The data stores 125 include a variety of information maintained by the corresponding retailer. For example, a loyalty data store 125 includes records for customers of the retailer, where each record may include customer identifying data and contact data, customer transaction history data, data relating to promotions offered to a customer, data relating to promotions redeemed by a customer, customer preferences or profile information, and so forth. An employee data store includes records for employees of the store, where each record may include employee identifying data and contact data, historical work dates and times, scheduled work days and times for future work days, identifiers for the terminals historically operated by the employee on each prior work day, total number of historical transactions performed by the employee for each prior work day, total number of historical price overrides performed by the employee on each prior work day, total number of historical returns performed by the employee on each prior work day, total number of historical transaction item voids performed by the employee on each prior work day, etc. A product data store may include item identifiers for products, item classifications, item barcodes, item descriptions, item pricing, etc.

At least one data store 125 includes transaction data for a given retailer's transaction system 123. The transaction data may include transaction records, where each transaction record includes a store identifier for the retailer's store that performed the transaction, a transaction type to indicate whether the transaction was performed online or in the store, an indication as to whether the transaction was a return or whether it was a purchase transaction, a terminal identifier for the terminal that performed the transaction (if the transaction is an in store transaction), a customer identifier for the customer of the transaction, a cashier identifier for a cashier if the transaction was cashier-assisted, time/date stamp information for the transaction, item codes for items purchased in the transaction, item prices, item categories, item discounts, redeemed promotions, an so forth. The transaction data may also include sales and loss information per store of the retailer such as, for a given period of time, total sales, sales by item, sales by item category, sales by store department, shrink per item, shrink per item category, shrink per store department, and so forth.

At least one data store 125 further includes security data for a given retailer's security system. The data store 125 includes a plurality of computer-vision metrics for analysis of video or images captured by a store's cameras 127 and provided through computer vision applications 113. Some of these metrics are related to shrink events for which shrink was identified or vision-based actions that were flagged as being potential shrink. The data store 125 further includes data relevant to shrink obtained from transaction system 123. Some example computer-vision metrics include, by way of example only, whether an item was detected as passing through a scan zone or not, a total count of items for the transaction versus a total count of items scanned for a given transaction, and item last detected in possession of the shopper and not also identified during a checkout, and other computer-vision metrics

Computer vision applications of system 100 process a variety of algorithms to analyze video captured of a retail environment (e.g., a checkout are) and provide identifiers in real time for customers and attendants as well as customer/attendant action identifiers that uniquely identify customer or attendant actions that occur during transactions at a given store. The computer vision applications 113 also provide terminal identifiers for terminals 120 associated with each transaction at the store. Each terminal identifier is linked to or associated with a specific location within the store. Furthermore, the computer vision applications provide event identifiers for shrink related events detected through analysis of the customer/attendant identifiers, customer/attendant action identifiers, and terminal identifiers.

A first MLM trainer 114 gathers historical transaction data and historical security data from the relevant data stores 135. The historical data includes information on past shrink events, transaction details, and known risk factors for the past shrink events. Once the first MLM trainer 114 trains shrink risk factor MLM 115 on the historical data, the trained shrink risk factor MLM 115 is configured to receive, as input data, real-time data provided by computer vision applications 113, transaction manager 124, and transaction system 123.

During training, the known risk factors are labeled as expected output from the shrink risk factor MLM 115. The shrink risk factor MLM 115 is trained to extract relevant factors from the provided historical shrink related events and historical transaction data and configure itself to provide the labeled known risk factors as output. The relevant risk factors include, by way of example only, time related factors (e.g., day of week, time of day, seasonality), basket content (e.g., item categories, brands, and item combinations in a given transaction, etc.), checkout channel (e.g., transaction at a point-of-sale (POS) terminal, a self-service terminal (SST), a mobile device, etc.), customer loyalty status and information, payment method (e.g., ACH, credit card, give card, check, debit card, etc.) being used for a given transaction, a specific cashier operating a given POS terminal for a given transaction, a specific customer operating a given SST for a given transaction, a specific attendant overseeing a pool or group of SSTs for given transactions, a specific POS terminal or a specific SST terminal being operated for a given transaction, and others. During training, shrink risk factor MLM 115 learns and derives patterns between the input and the known shrink events to provide as output the shrink risk factors.

First trainer 114 feeds the historical data and labeled output data to the shrink risk factor MLM 115 and adjusts the MLM's 115 parameters based on its performance in predicting the shrink risk factors associated with the known shrink events. First trainer 114 then uses a separate unlabeled test data set to test the MLM's performance. Once an acceptable level of accuracy is obtained from shrink factor MLM 115, shrink factor MLM 115 can be deployed for use in real-time prediction of shrink risk factors associated with shrink events. The shrink risk factor MLM 115 is designed to continuously update and refine its predictions based on new data received from the computer vision applications and real-time transaction data from transaction manager 124 and transaction system 123. This allows shrink risk MLM 115 to adapt to changing patterns and emerging risk factors.

By combining historical data with real-time inputs, the shrink risk factor MLM 115 can provide up-to-date and context-aware risk assessments via predicted shrink risk factors. This output then serves as input for the shrink mitigation recommendation MLM 116, which uses these risk factors to generate specific prescriptive actions to mitigate and/or prevent shrink events.

A second MLM trainer 114 gathers historical data on shrink risk factors and corresponding effective prescriptive actions that were taken to mitigate or prevent shrink events. This data is obtained from relevant data stores 125 and includes information on past shrink events, the risk factors associated with those events, the actions taken that successfully reduced or prevented shrink, and prescriptive actions take that were not successful in reducing or preventing shrink. During the training of the shrink mitigation recommendation MLM 116, the shrink risk factors are used as input features, while the corresponding effective prescriptive actions are labeled as the expected output from the shrink mitigation recommendation MLM 116. This setup allows the shrink mitigation recommendation MLM 116 to learn the relationships between specific risk factors and the most effective actions to address them.

The second trainer 114 processes this historical data to extract relevant features and create training examples. Each example consists of a set of shrink risk factors (input) paired with the corresponding effective prescriptive action(s) (output). The trainer 114 may also incorporate additional contextual information, such as store layout, staffing levels, or historical shrink rates, to provide a more comprehensive basis for generating recommendations.

The shrink mitigation recommendation MLM 116 may be trained using supervised learning techniques. The shrink mitigation recommendation MLM 116 learns to associate specific combinations of risk factors with the most effective prescriptive actions. This training process involves iteratively adjusting the MLM's parameters to minimize the difference between its predicted recommendations and the known effective actions from the historical data.

To ensure the MLM's effectiveness, the second trainer 114 may use a separate validation dataset to evaluate the MLM's performance. This dataset contains shrink risk factors and known effective actions that were not used during the training process. The trainer 114 assesses the MLM's ability to generate appropriate recommendations for these unseen examples.

Once the shrink mitigation recommendation MLM 116 achieves satisfactory performance on the validation dataset, it is deployed for real-time production use. In operation, the shrink mitigation recommendation MLM 116 takes the shrink risk factors output by the shrink risk factor MLM 115 as input and generates specific prescriptive recommendations to mitigate or prevent potential shrink events. The shrink mitigation recommendation MLM 116 is designed to continuously learn and adapt based on the effectiveness of its recommendations. As new data becomes available on the success or failure of implemented recommendations, the shrink mitigation recommendation MLM 116 can be fine-tuned to improve its future suggestions. This ongoing learning process ensures that the shrink mitigation recommendation MLM 116 remains effective as shrink patterns and prevention strategies evolve over time.

By leveraging the output of the shrink risk factor MLM 115 and generating targeted prescriptive actions, the shrink mitigation recommendation MLM 116 provides retailers with actionable insights to proactively address potential shrink events. This dual-MLM approach allows for a more nuanced and effective strategy in combating retail shrink.

The APIs 117 provide an interface between the shrink mitigation recommendation MLM 116 and various store systems, applications, and/or services by enabling real-time integration of prescriptive actions into existing retail operations. When the shrink mitigation recommendation MLM 116 generates mitigation and prevention recommendations based on the risk factors identified by the shrink risk factor MLM 115, these recommendations may be passed to the APIs 117 for distribution.

For real-time interventions at the terminals 120, the APIs 117 transmit relevant recommendations directly to the transaction manager 124 on the retailer terminals 120. This allows for immediate action to be taken during ongoing transactions. For example, if a high-risk transaction is identified, the API 117 might trigger an alert to the cashier or attendant through the transaction interface, prompting them to take specific preventive measures. Similarly, the APIs 117 can send broader recommendations to the transaction system 123 on the retailer server 120. These might include updates to transaction processing rules or triggers for additional security measures based on the current risk assessment.

For store management applications, the APIs 117 may package and transmit recommendations in a format suitable for consumption by various management tools and dashboards. This could include sending alerts to store managers'mobile devices, updating staffing recommendation systems, or providing input to loss prevention planning tools. The APIs 117 are designed to be flexible and extensible, allowing for integration with a wide range of store systems and services. This ensures that the shrink prevention recommendations can be effectively implemented across different aspects of store operations, from individual transactions to overall store management strategies.

A few examples of how the overall system 100 works are now presented for further comprehension of various embodiments of the invention. In the case of self-checkout fault prevention, the computer vision applications 113 analyze video feeds from cameras 127 at self-checkout terminals. They detect a pattern of customers struggling to scan specific items, particularly those with hard-to-find barcodes and/or struggling to navigate terminal interfaces of a terminal 120. This information is fed into the shrink risk factor MLM 115 as shrink event identifiers, which identifies this as a significant shrink risk factor for unintentional shrink. The shrink mitigation recommendation MLM 116 then generates a recommendation to improve barcode placement, provide additional training for self-checkout attendants or cashiers, and/or to modify the terminal interfaces. The APIs 117 transmit this recommendation to the store manager's dashboard, prompting them to take action to address the issue.

In the case of real-time transaction intervention during a transaction, the transaction manager 124 sends real-time data to the shrink risk factor MLM 115. The MLM 115 identifies a high risk of shrink based on factors such as the time of day, basket content, and customer behavior detected by the computer vision applications 113. The shrink mitigation recommendation MLM 116 generates a recommendation for immediate intervention. The APIs 117 then send an alert to the transaction manager 124, which displays a prompt on the cashier's screen asking them to verify that all items have been properly scanned.

In the case of staffing optimization, the shrink risk factor MLM 115 analyzes historical transaction data from the data stores 125 and identifies that certain cashiers have a higher rate of non-deliberate shrink during peak hours. The shrink mitigation recommendation MLM 116 generates a recommendation to adjust staffing schedules. The APIs 117 transmit this recommendation to the store's scheduling system, suggesting that these cashiers be assigned to less busy periods, provided additional training, and/or provided with additional support during peak hours.

In the case of targeted training, the system 100 identifies that a specific self-checkout attendant is associated with a higher rate of shrink incidents. The shrink mitigation recommendation MLM 116 suggests targeted training for this employee. The APIs 117 send this recommendation to the store's training management system, triggering the creation of a personalized training module focusing on areas where the attendant needs improvement, such as assisting customers with PLU entry for produce items.

These examples demonstrate how the system 100 integrates real-time data analysis, machine learning predictions, and automated recommendations to provide a comprehensive approach to shrink prevention and mitigation across various aspects of store operations.

System 100 offers several key technical benefits over conventional retail shrink prevention systems:
Real-time Analysis and Intervention: Unlike traditional systems that often detect shrink after it occurs, system 100 leverages real-time data from computer vision applications 113 and transaction systems 123/124 to identify potential shrink events as they happen. This allows for immediate intervention, significantly reducing losses.
Dual-MLM Approach: The combination of the shrink risk factor MLM 115 and shrink mitigation recommendation MLM 116 provides a more nuanced and effective analysis of shrink risks. This approach not only identifies potential shrink events but also generates specific, actionable recommendations to prevent them.
Continuous Learning and Adaptation: Both MLMs 115 and 116 in system 100 are designed to continuously update and refine their predictions based on new data. This ensures that the system 100 remains effective as shrink patterns and prevention strategies evolve over time, unlike static rule-based systems.
Comprehensive Integration: Through APIs 117, system 100 seamlessly integrates with various store systems and services. This allows for a holistic approach to shrink prevention, addressing issues across different aspects of store operations, from individual transactions to overall store management strategies.
Prescriptive Recommendations: Instead of merely flagging potential issues, system 100 provides specific, actionable recommendations. This guides store staff and management in taking the most effective steps to prevent shrink, improving the overall efficiency of loss prevention efforts.
Addressing Non-Deliberate Shrink: System 100 is particularly effective in identifying and mitigating non-deliberate shrink, such as issues arising from self-checkout faults. This addresses a significant source of loss that is often overlooked by conventional systems focused primarily on deliberate theft.

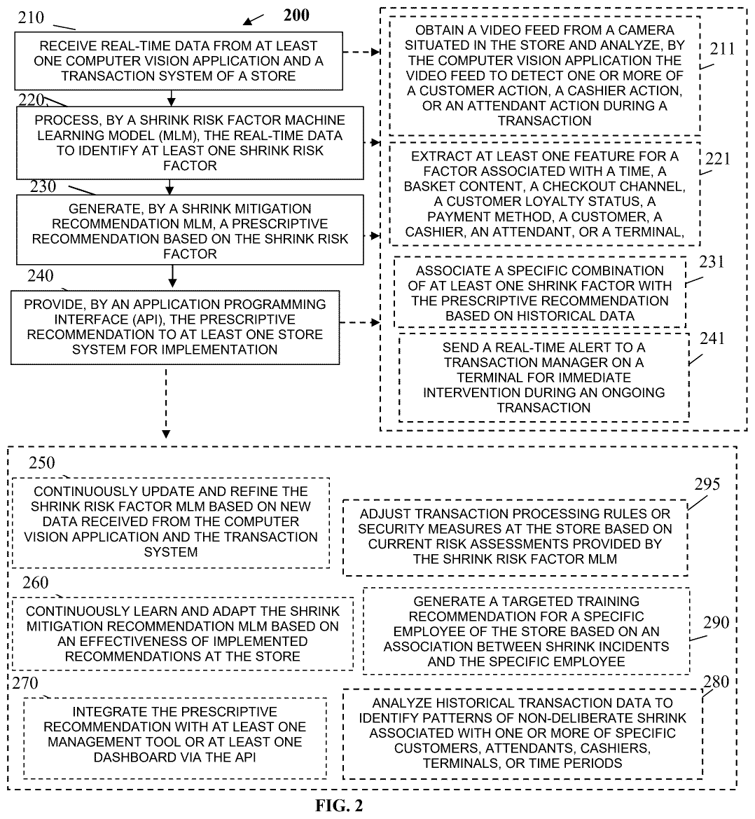

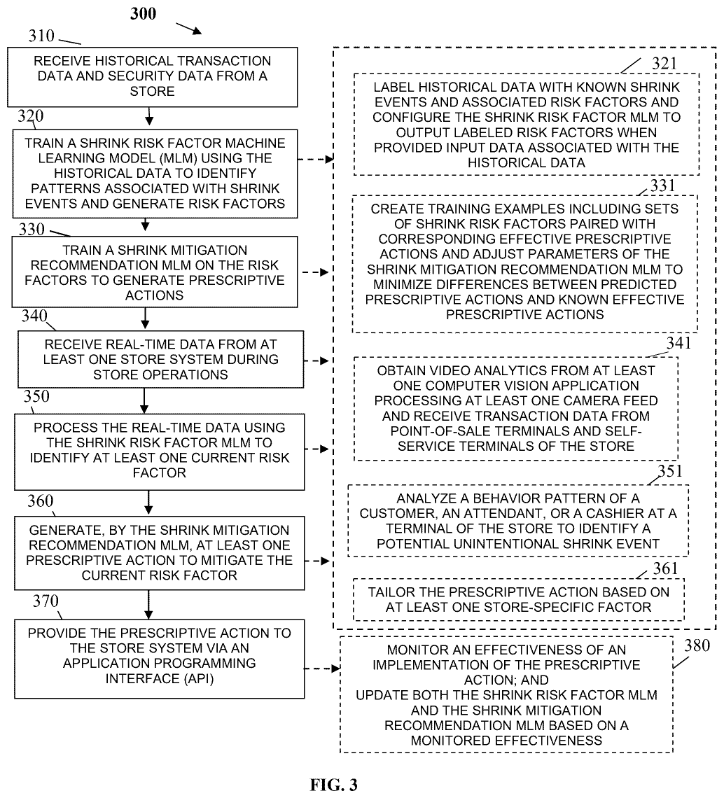

By combining advanced machine learning techniques with comprehensive data integration and real-time analysis, system 100 offers a proactive, adaptive, and highly effective approach to retail shrink prevention that surpasses the capabilities of conventional systems. The above-referenced embodiments and other embodiments are now discussed with reference to FIGS. 2 and 3.

FIG. 2 is a flow diagram of a method 200 for providing retail shrink mitigation and prevention, according to an example embodiment.

The software module(s) that implements the method 200 is referred to as a “shrink prevention manager.” The shrink prevention manager is implemented as executable instructions programmed and residing within memory and/or a non-transitory computer-readable (processor-readable) storage medium and executed by one or more processors of one or more devices. The processor(s) of the device(s) that executes the shrink prevention manager are specifically configured and programmed to process the shrink prevention manager. The shrink prevention manager has access to one or more network connections during its processing. The connections can be wired, wireless, or a combination of wired and wireless.

In an embodiment, the device that executes shrink prevention manager is cloud 110. In an embodiment, the device that executes shrink store context predictor is server 110. In an embodiment, the device that executes shrink prevention manager is retailer server 120. In an embodiment, the shrink prevention manager is all of, or some combination of 113, 114, 115, 116, and/or 117. In an embodiment, the shrink prevention manager is provided to a retail server 120, a store terminal 120, and/or a user-operated device as a SaaS integrated via API calls from applications executed on the retail server 120, store terminal 120, and/or the user-operated device.

At 210, the shrink prevention manager receives real-time data from at least one computer-vision application 113 and a transaction system 123 of a store. In an embodiment, at 211, the shrink prevention manager obtains at least one video feed from at least one camera 127 situated in the store. The computer vision application 113 analyzes the video feed to detect one or more of a customer action, a cashier action, or an attendant action during a transaction at the store.

At 220, the shrink prevention manager uses a shrink risk factor MLM 115 and the shrink risk factor MLM 115 processes the real-time data to identify at least one shrink risk factor. In an embodiment, at 221, the shrink risk factor MLM 115 extracts at least one feature for a factor associated with time, a basket content, a checkout channel, a customer loyalty status, a payment method, a specific customer, a specific cashier, a specific attendant of SSTs, or a terminal.

At 230, the shrink prevention manager uses a shrink mitigation recommendation MLM 116 and the shrink mitigation recommendation MLM 116 generates a prescriptive recommendation based on the shrink risk factor. In an embodiment, at 231, the shrink recommendation MLM associates a specific combination of at least one shrink factor with the prescriptive recommendation based on historical data.

At 240, the shrink prevention manager uses an API 117, and the API 117 provides the prescriptive recommendation to at least one store system for implementation. In an embodiment, at 241, the API 117 sends a real-time alert to a transaction manager 124 on a terminal 120 of the store for immediate intervention during an ongoing transaction to prevent or mitigate potential shrink for the ongoing transaction.

In an embodiment, at 250, the shrink prevention manager continuously updates and refines the shrink risk factor MLM 115 based on new data received from the computer-vision application 113 and the transaction system 123. In an embodiment, at 260, the shrink prevention manager continuously learns and adapts the shrink mitigation recommendation MLM 116 based on an effectiveness of implemented recommendations at the store to mitigate and prevent shrink.

In an embodiment, at 270, the shrink prevention manager integrates the prescriptive recommendation with at least one management tool/service/application or at least one dashboard service via the API 117. In an embodiment, at 280, the shrink prevention manager analyzes historical transaction data to identify patterns of non-deliberate shrink associated with one or more specific customers, specific attendants, specific cashiers, specific terminals 120, and specific time periods of business operations for the store.

In an embodiment, at 290, the shrink mitigation recommendation MLM 116 generates a targeted training recommendation for a specific employee of the store based on an association between shrink incidents and the specific employee. In an embodiment, at 295, the shrink prevention manager adjusts transaction processing rules or security measures to prevent or mitigate shrink at the store based on current risk assessments provided by the shrink risk factor MLM 115.

FIG. 3 is a flow diagram of another method 300 for providing retail shrink mitigation and prevention, according to an example embodiment. The software module(s) that implements the method 300 is referred to as a “shrink intervention manager.” The shrink intervention manager is implemented as executable instructions programmed and residing within memory and/or a non-transitory computer-readable (processor-readable) storage medium and executed by one or more processors of one or more devices. The processor(s) of the device(s) that executes the shrink intervention manager are specifically configured and programmed to process the shrink intervention manager. The shrink intervention manager has access to one or more network connections during its processing. The network connections can be wired, wireless, or a combination of wired and wireless.

In an embodiment, the device that executes the shrink intervention manager is cloud 110. In an embodiment, the device that executes the shrink intervention manager is server 110. In an embodiment, the device that executes the shrink intervention manager is retailer server 120. In an embodiment, the shrink intervention manager is provided to a retail server 120, a store terminal 120, and/or a user-operated device as a SaaS integrated into applications executing on the server 120, store terminal 120, and/or user-operated device via API calls of APIs 117.

In an embodiment, the shrink intervention manager is all of, or some combination of 113, 114, 115, 116, 117, and/or method 200. The shrink intervention manager presents another and, in some ways, enhanced processing perspective from that which was discussed above with the method 200 of the FIG. 2.

At 310, the shrink intervention manager receives historical transaction data and security data from a store. The historical data is obtained from datastores 125.

At 320, the shrink intervention manager trains a shrink risk factor MLM 115 using the historical data to identify patterns associated with shrink events and to generate risk factors. In an embodiment, at 321, the shrink intervention manager labels the historical data with known shrink events and associated risk factors. The shrink intervention manager configures the shrink risk factor MLM 115 to output labeled risk factors when provided input data associated with the historical data.

At 330, the shrink intervention manager trains a shrink mitigation recommendation MLM 116 on the risk factors to generate prescriptive actions or recommendations. In an embodiment, at 331, the shrink intervention manager creates training examples including sets of shrink risk factors paired with corresponding effective prescriptive actions. The shrink intervention manager adjusts parameters of the shrink mitigation recommendation MLM 116 to minimize differences between predictive prescriptive actions and known effective prescriptive actions.

At 340, the shrink intervention manager receives real-time data from at least one store system during store operations at the store. In an embodiment, at 341, the shrink intervention manager obtains video analytics from at least one computer-vision application 113 processing at least one camera feed. Furthermore, the shrink intervention manager receives transaction data from POS terminals 120 and SSTs 120 of the store.

At 350, the shrink intervention manager processes the real-time data using the shrink risk factor MLM 115 to identify at least one current risk factor associated with shrink. In an embodiment, at 351, the shrink risk factor MLM 115 analyzes a behavior or action pattern of a customer, an attendant, or a cashier at a terminal 120 of the store to identify a potential unintentional shrink event.

At 360, the shrink mitigation recommendation MLM 116 generates at least one prescriptive action to mitigate or to prevent the current risk factor. In an embodiment, at 361, the shrink mitigation recommendation MLM 116 tailors the prescriptive action based on at least one store-specific factor associated with shrink at the store.

At 370, the shrink intervention manager provides the prescriptive action to the store system via an API 117. In an embodiment, at 380, the shrink intervention manager monitors the effectiveness of an implementation of the prescriptive action and updates both the shrink risk factor MLM 115 and the shrink mitigation recommendation MLM 116 based on a monitored effectiveness.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a cloud server, real-time data from at least one computer vision application and a transaction system of a store;
processing, by a shrink risk factor machine learning (MLM), the real-time data to identify at least one shrink risk factor;
generating, by a shrink mitigation recommendation MLM, a prescriptive recommendation based on the at least one shrink risk factor; and
providing, by an application programming interface (API), the prescriptive recommendation to at least one store system for implementation.

2. The method of claim 1, wherein receiving further includes obtaining a video feed from a camera situated in the store and analyzing, by the at least one computer vision application the video feed to detect one or more of a customer action or an attendant action during a transaction.

3. The method of claim 1, wherein processing further includes extracting at least one feature including one or more of a time-related factor, basket content, checkout channel, a customer loyalty status, a payment method, a specific customer, a specific cashier, a specific attendant, or a specific terminal.

4. The method of claim 1, wherein generating further includes associating a specific combination of the at least one shrink factor with the prescriptive recommendation based on historical data.

5. The method of claim 1, wherein providing further includes sending a real-time alert to a transaction manager on a terminal for intervention during an ongoing transaction.

6. The method of claim 1, further comprising:
continuously updating and refining the shrink risk factor MLM based on new data received from the at least one computer vision application and the transaction system.

7. The method of claim 1, further comprising:
continuously learning and adapting the shrink mitigation recommendation MLM based on an effectiveness of implemented recommendations at the store.

8. The method of claim 1, further comprising:
integrating the prescriptive recommendation with at least one store management tool or at least one dashboard via the API.

9. The method of claim 1, further comprising:
analyzing historical transaction data to identify patterns of non-deliberate shrink associated with one or more of specific cashiers, specific attendants of self-service terminals, specific customers, specific terminals, or specific time periods.

10. The method of claim 1, further comprising:
generating a targeted training recommendation for a specific employee of the store based on an association between shrink incidents and the specific employee.

11. The method of claim 1, further comprising:
adjusting transaction processing rules or security measures based on current risk assessments provided by the shrink risk factor MLM.

12. A method, comprising:
receiving historical transaction data and security data from a store;
training a shrink risk factor machine learning (MLM) using the historical data to identify patterns associated with shrink events and generate risk factors;
training a shrink mitigation recommendation MLM on the risk factors to generate prescriptive actions;
receiving real-time data from at least one store system during store operations;
processing the real-time data using the shrink risk factor MLM to identify at least one current risk factor;
generating, by the shrink mitigation recommendation MLM, at least one prescriptive action to mitigate the at least one current risk factor; and
providing the at least one prescriptive action to the at least one store system via an application programming interface (API).

13. The method of claim 12, wherein training the shrink risk factor MLM further includes labeling historical data with known shrink events and associated risk factors and configuring the shrink risk factor MLM to output labeled risk factors when provided with input data associated with the historical data.

14. The method of claim 12 wherein training the shrink recommendation MLM further includes creating training examples comprising sets of shrink risk factors paired with corresponding effective prescriptive actions and adjusting parameters of the shrink mitigation recommendation MLM to reduce deviations between predicted prescriptive actions and known effective prescriptive actions.

15. The method of claim 12, wherein receiving the real-time data further includes obtaining video analytics from at least one computer vision application processing at least one store camera feed and receiving transaction data from point-of-sale terminals and self-service terminals of the store.

16. The method of claim 12, wherein processing further includes analyzing a behavior pattern of a customer, an attendant, or a cashier at a terminal in the store to identify a potential unintentional shrink event.

17. The method of claim 12, wherein generating further includes tailoring the at least one prescriptive action based on at least one store-specific factor.

18. The method of claim 12, further comprising:
monitoring an effectiveness of an implementation of the at least one prescriptive action; and
updating both the shrink risk factor MLM and the shrink mitigation recommendation MLM based on a monitored effectiveness.

19. A system, comprising:
a cloud server comprising:
a shrink risk factor machine learning (MLM) configured to process real-time store data and output shrink risk factors;
a shrink mitigation recommendation MLM configured to generate prescriptive actions based on the shrink factors; and
an application programming interface (API) configured to provide the prescriptive actions to at least one store system of a store;
wherein the cloud server is configured to perform operations comprising:
receiving historical and real-time data from at least one store computer vision application and a store transaction system;
continuously updating the shrink risk factor MLM and the shrink mitigation recommendation MLM based on effectiveness of implemented prescriptive actions at the store; and
providing at least one real-time shrink prevention action generated by the shrink mitigation recommendation MLM to the at least one store system during an ongoing transaction at the store.

20. The system of claim 19, wherein the shrink risk factor MLM is further configured to:
analyze behavior patterns of cashiers, attendants, and customers at terminals of the store; and
identify potential unintentional shrink events based on detected struggles with scanning items or navigating terminal interfaces during transactions at the terminals.
